(19) United States
(12) Patent Application Publication
(10) Pub. No.: US 2014/0192273 A1
(43) Pub. Date: Jul. 10, 2014

(54) INPUT DEVICE

(71) Applicant: FUJITSU COMPONENT LIMITED, Tokyo (JP)

(72) Inventors: Takeshi OKUYAMA, Tokyo (JP); Nobuo Yatsu, Tokyo (JP); Nobuyoshi Shimizu, Tokyo (JP)

(73) Assignee: FUJITSU COMPONENT LIMITED, Tokyo (JP)

(21) Appl. No.: 14/097,497

(22) Filed: Dec. 5, 2013

(30) Foreign Application Priority Data
Jan. 7, 2013 (JP) 2013-000706

(51) Int. Cl. G06F 3/0354

(52) U.S. Cl. CPC G06F 3/03545
USPC 349/12

(57) ABSTRACT

An input device includes: an operation panel including: a plurality of first conductive patterns that extend in a first direction, and are arranged in a second direction crossing the first direction; and a plurality of second conductive patterns that extend in the second direction, and are arranged in the first direction; an indicator that includes a charge unit charged with electric charges; and a position detection unit that, when the indicator comes close to the operation panel, measures electric potentials by electric charges which arise in the first conductive patterns and the second conductive patterns by the charge unit of the indicator, and detects a position of the indicator based on a measurement result of the electric potentials.

### CROSS-REFERENCE TO RELATED APPLICATIONS

This application is based upon and claims the benefit of priority of the prior Japanese Patent Application No. 2013-000706 filed on Jan. 7, 2013, the entire contents of which are incorporated herein by reference.

### FIELD

A certain aspect of the embodiments is related to an input device, e.g. an input device corresponding to a hovering function.

### BACKGROUND

With expansion of a market for an information communication apparatus and a business terminal, the demand for a touch input device, such as a touch panel and a touchpad in which coordinates can be detected easily, is expanded. The touch input device is used by touching an operation panel with a finger or an indicator. There has been known a touch input device of an electric capacity system which detects the position of a finger based on the change of an electric capacity by having contacted the finger to the operation panel (e.g. Japanese Laid-open Patent Publication No. 2010-191797). There has been known a touch pen as the indicator which receives at a tip an electric charge provided from an electrostatic induction generating unit provided in a main body (e.g. Japanese Registered Utility Model No. 3176454).

Recently, there is required a function (what is called the hovering function) in which the operation panel can be used in a state where an indicator is away from the operation panel in addition to a state where a finger or the indicator contacts the operation panel. There are proposed various input devices corresponding to such a hovering function (e.g. Japanese Laid-open Patent Publication No. 2011-138180, Japanese Laid-open Patent Publication No. 2011-164801, Japanese National Publication of International Patent Application No. 2005-537570, and Japanese National Publication of International Patent Application No. 2011-519458).

### SUMMARY

According to an aspect of the present invention, there is provided an input device includes: an operation panel including: a plurality of first conductive patterns that extend in a first direction, and are arranged in a second direction crossing the first direction; and a plurality of second conductive patterns that extend in the second direction, and are arranged in the first direction; an indicator that includes a charge unit charged with electric charges; and a position detection unit that, when the indicator comes close to the operation panel, measures electric potentials by electric charges which arise in the first conductive patterns and the second conductive patterns by the charge unit of the indicator, and detects a position of the indicator based on a measurement result of the electric potentials.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the whole composition of an input device according to a first embodiment;

FIG. 2 is an exploded perspective view of an operation panel;

FIG. 3 is a cross-section view of an indicator;

FIG. 4A is a diagram for explaining a phenomenon which arises in first conductive patterns when the indicator is in a hovering state;

FIG. 4B is a diagram for explaining a phenomenon which arises in second conductive patterns;

FIG. 5 is a flowchart for explaining the control of a position detection unit included in the input device according to the first embodiment;

FIG. 6 is a flowchart for explaining the control of the position detection unit included in the input device according to a second embodiment; and

FIG. 7A and 7B are diagrams for explaining approximate lines of electric potentials calculated by the position detection unit included in the input device according to the second embodiment.

### DESCRIPTION OF EMBODIMENTS

The above-mentioned conventional input device corresponding to the hovering function equips the indicator with a power supply circuit, a resonant circuit, or the like, and equips an operation panel side with a transmitter sending an electric wave, so that the conventional input device has a complicate composition. There is proposed an input device which detects a state (i.e., the hovering state) where the indicator is away from the operation panel, based on the change of a capacity. However, it is difficult for this input device to detect the change of the capacity, and hence to detect an exact touch position.

A description will now be given of embodiments of the present invention with reference to attached drawings.

### First Embodiment

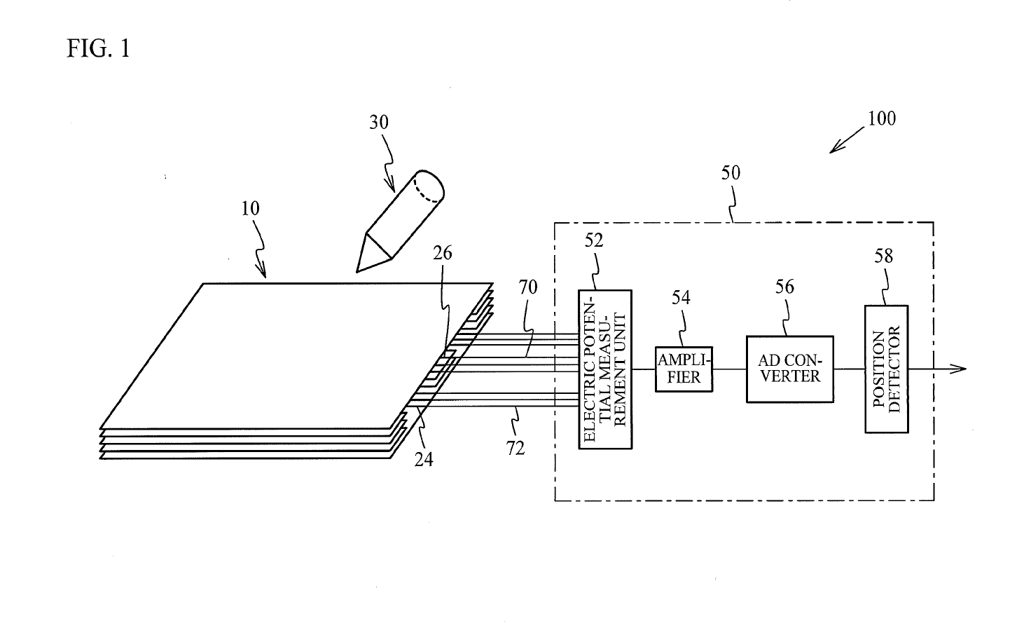

FIG. 1 is a diagram illustrating the whole composition of an input device according to a first embodiment.

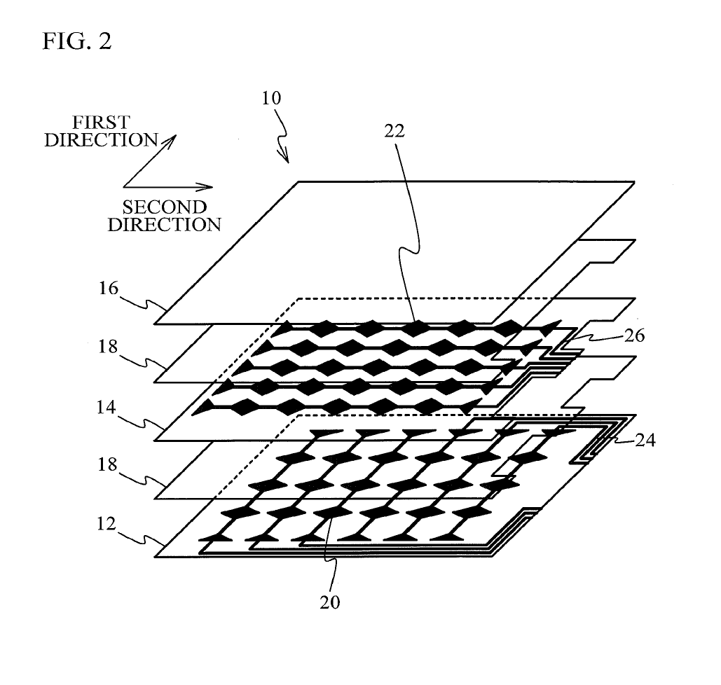

As illustrated in FIG. 1, an input device 100 according to a first embodiment includes an operation panel 10, an indicator 30, and a position detection unit 50. First, a description will be given of the operation panel 10 by use of FIG. 2. FIG. 2 is an exploded perspective view of the operation panel 10. The operation panel 10 is arranged on a front surface of a display, such as a LCD (Liquid Crystal Display). As illustrated in FIG. 2, the operation panel 10 has a laminated structure in which a plurality of layers including a bottom film 12, a top film 14 and a cover film 16 are pasted up by an adhesive 18. The bottom film 12 and the top film 14 are transparent films, for example, and a PET (polyethylene terephthalate) film or the like can be used as the bottom film 12 and the top film 14. The cover film 16 is also a transparent film, for example, and the PET film or the like can be used as the cover film 16. Instead of the cover film 16, a transparent cover glass may be used. For example, a transparent OCA (Optical Clear Adhesive) double-stick tape can be used as the adhesive 18.

On an upper surface of the bottom film 12, a plurality of first conductive patterns 20 which extend in a first direction are arranged in a second direction crossing the first direction. On an upper surface of the top film 14, a plurality of second conductive patterns 22 which extend in the second direction are arranged in the first direction. For example, the first direction is orthogonal to the second direction. The first conductive patterns 20 and the second conductive patterns 22 are formed with a transparent conductive film, for example, and can be formed with an ITO (indium oxide tin) film. The display, such as the LCD (Liquid Crystal Display), is arranged under the bottom film 12. An upper side of the cover film 16 becomes an operation surface.

Wiring patterns 24 and 26 are connected to the first conductive patterns 20 and the second conductive patterns 22, respectively. Wiring patterns 24 and 26 are connected to the position detection unit 50 via wirings 70 and 72, as illustrated in FIG. 1. Thereby, the first conductive patterns 20 and the second conductive patterns 22 are electrically connected to the position detection unit 50.

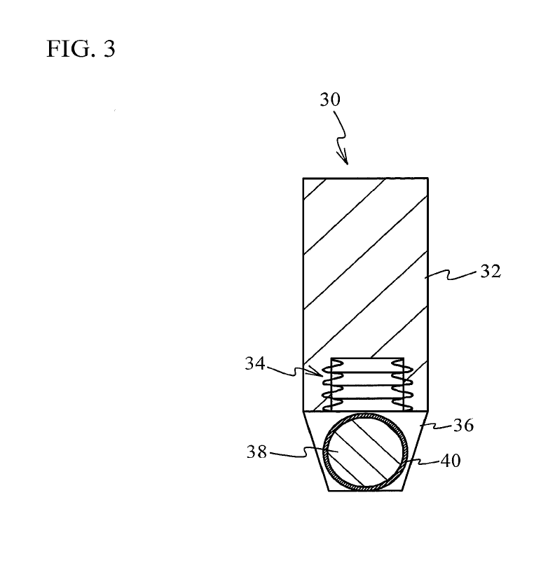

Next, a description will be given of the indicator 30 by use of FIG. 3. FIG. 3 is a cross-section view of the indicator 30. FIG. 3 illustrates a cross-section surface in which the indicator 30 is cut in an extended direction. In the indicator 30, a charge unit 36 is combined with a tip of a body unit 32 by a combination unit 34 composed of a screw, as illustrated in FIG. 3. Since the combination unit 34 is composed of the screw, the charge unit 36 is detachably combined with the body unit 32. Here, the combination unit 34 is not limited to the screw. As long as the charge unit 36 is detachable from the body unit 32, a concavity, a convexity and the like may be formed on the charge unit 36 and the body unit 32, respectively, and be fitted in each other, for example. Also, a circuit or the like is not provided in the body unit 32.

The charge unit 36 includes a charge body 38 storing an electric charge. A negative electric charge is stored into the charge body 38, for example. The charge unit 36 has an electric charge (for example, the negative electric charge). The charge body 38 is composed of an electret, for example. There is an advantage that the electret is excellent in an electric charge retainment property. The charge body 38 is not limited to the electret, and may be composed of a charged capacitor, or the like.

The circumference of the charge body 38 is covered with an insulating layer 40. For example, the circumference of the charge body 38 is completely covered with the insulating layer 40. Thereby, discharging the electric charge stored into the charge body 38 can be restrained. Here, the embodiment is not limited to a case where the charge unit 36 includes the charge body 38 storing the electric charge, and the embodiment may be a case where the electric charge is stored into the whole charge unit 36 and the circumference of the charge unit 36 is covered with an insulating layer, for example.

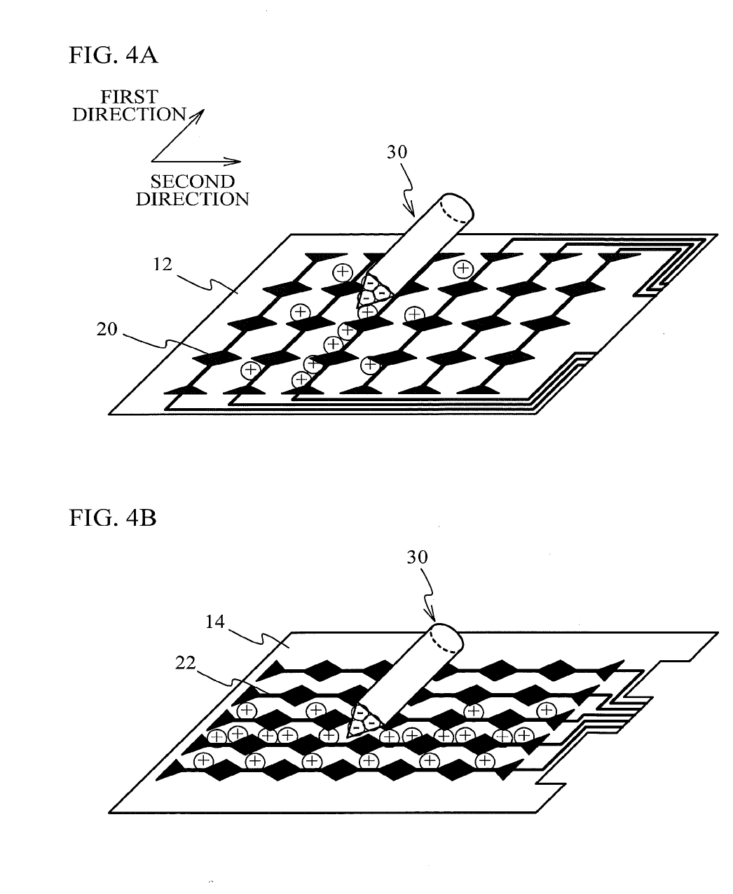

Here, in a state (i.e. a hovering state) where the indicator 30 comes close to the operation panel 10 while being away from the operation panel 10, a phenomenon which arises in the operation panel 10 is explained. FIG. 4A is a diagram for explaining a phenomenon which arises in the first conductive patterns 20 when the indicator 30 is in the hovering state. FIG. 4B is a diagram for explaining a phenomenon which arises in the second conductive pattern 22. A tip of the indicator 30 includes the charge unit 36 having the electric charge (for example, the negative electric charge), as illustrated in FIGS. 4A and 4B. Therefore, when the indicator 30 comes close to the operation panel 10, electric charges with an opposite polarity (for example, a positive electric charge) which negate an electric potential generated by the charge unit 36 arise in the first conductive patterns 20 and the second conductive patterns 22.

As the indicator 30 comes close to the operation panel 10, the electric charges which arise in the first conductive patterns 20 and the second conductive patterns 22 increase. As the indicator 30 is away from the operation panel 10, the electric charges which arise in the first conductive patterns 20 and the second conductive patterns 22 decrease. Therefore, the electric potentials of the first conductive patterns 20 and the second conductive patterns 22 rise as the indicator 30 is close to the operation panel 10. The position detection unit 50 described later detects a position of the indicator 30 by use of this phenomenon.

A description will be given of the position detection unit 50 by use of FIG. 1. As illustrated in FIG. 1, the position detection unit 50 includes an electric potential measurement unit 52, an amplifier 54, an analog-digital (AD) converter 56, and a position detector 58.

The electric potential measurement unit 52 measures the electric potentials of the first conductive patterns 20 in turn. The electric potential measurement unit 52 measures an electric potential difference generated between a ground and the first conductive patterns 20, for example. Moreover, the electric potential measurement unit 52 measures the electric potentials of the second conductive patterns 22 in turn.

The electric potential measurement unit 52 measures an electric potential difference generated between the ground and the second conductive patterns 22, for example.

The amplifier 54 amplifies an electric potential measured with the electric potential measurement unit 52. The AD converter 56 converts an analog signal indicating the electric potential amplified by the amplifier 54 into digital data, and provides the digital data to the position detector 58.

The position detector 58 is composed of a CPU (Central Processing Unit), for example. The position detector 58 specifies one of the first conductive patterns 20 and one of the second conductive patterns 22 in which an absolute value of an electric potential is maximum, from the measurement result of the electric potentials measured by the electric potential measurement unit 52. Then, the position detector 58 detects a position where the specified first conductive pattern 20 crosses the specified second conductive pattern 22, as a position of the indicator 30. The position detector 58 may have a function to detect a distance from the operation panel 10 to the indicator 30, by the strength of the electric potential which arises in the first conductive pattern 20 and/or the second conductive pattern 22.

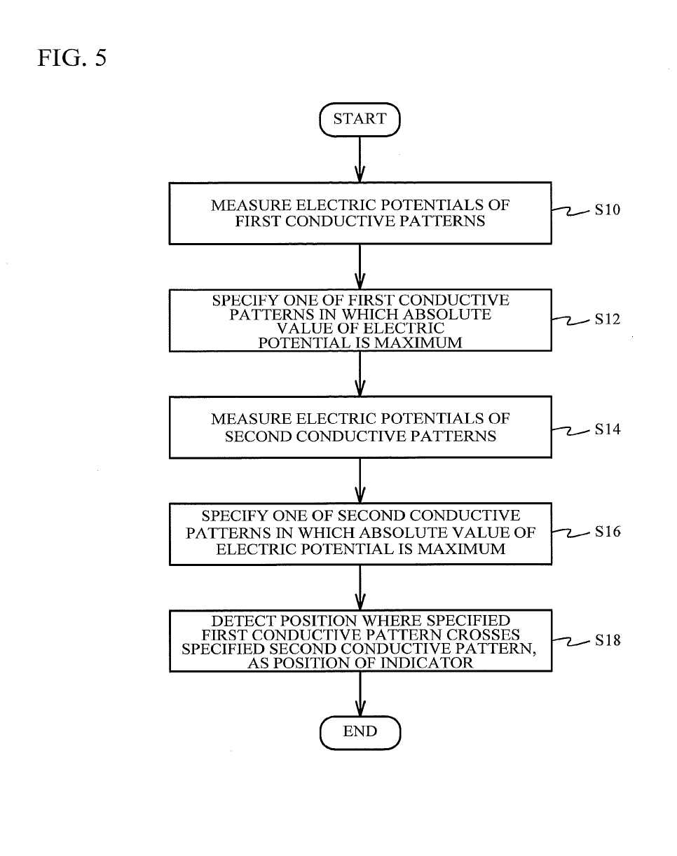

FIG. 5 is a flowchart for explaining the control of the position detection unit 50 included in the input device 100 according to the first embodiment. As illustrated in FIG. 5, the electric potential measurement unit 52 measures the electric potentials of the first conductive patterns 20 from the edge in turn (step S10). As explained in FIG. 4, in the state (i.e., the hovering state) where the indicator 30 comes close to the operation panel 10, the electric potential difference arises between the first conductive patterns 20. The position detector 58 specifies one of the first conductive patterns 20 in which the absolute value of the electric potential is maximum, from the measurement result of the electric potentials measured by the electric potential measurement unit 52 in step S10 (step S12).

Following the measurement of the electric potentials of the first conductive patterns 20, the electric potential measurement unit 52 measures the electric potentials of the second conductive patterns 22 from the edge in turn (step S 14). As with the first conductive patterns 20, in the state (i.e., the hovering state) where the indicator 30 comes close to the operation panel 10, the electric potential difference arises between the second conductive patterns 22. The position detector 58 specifies one of the second conductive patterns 22 in which the absolute value of the electric potential is maximum, from the measurement result of the electric potentials measured by the electric potential measurement unit 52 in step S14 (step S16).

Then, the position detector 58 detects a position where the first conductive pattern 20 specified in step S12 crosses the second conductive pattern 22 specified in step S16, as the position of the indicator 30 (step S18).

As described above, according to the first embodiment, when the indicator 30 that includes the charge unit 36 having the electric charge comes close to the operation panel 10, the electric potential measurement unit 52 measures the electric potentials by electric charges which arise in the first conductive patterns 20 and the second conductive patterns 22 by the charge unit 36. The position detector 58 detects the position of the indicator 30 based on the measurement result of the electric potentials. For example, the position detector 58 specifies one of the first conductive patterns 20 in which the absolute value of the electric potential is maximum, and one of the second conductive patterns 22 in which the absolute value of the electric potential is maximum, and detects the position where the specified first conductive pattern 20 crosses the specified second conductive pattern 22, as the position of the indicator 30. Thus, the electric potential measurement unit 52 measures the electric potentials by electric charges which arise in the first conductive patterns 20 and the second conductive patterns 22 by the charge unit 36, and the position detector 58 detects the position of the indicator 30, so that the position of the indicator 30 can be detected with high accuracy even in the state (i.e., the hovering state) where the indicator 30 is away from the operation panel 10. By using the electric charge in the charge unit 36 for the position detection of the indicator 30, the indicator 30 does not need to include a power supply circuit, a resonant circuit, or the like, and the indicator 30 can be made into simple composition. Thus, according to the first embodiment, accurate position detection can be achieved by simple composition.

The position detector 58 may have a function to detect a distance from the operation panel 10 to the indicator 30, by the strength of the electric potential which arises in the first conductive pattern 20 and/or the second conductive pattern 22.

As illustrated in FIG. 3, the indicator 30 includes: the body unit 32 that is not provided with circuits; and the charge unit 36 that has the charge body 38 storing the electric charge and the insulating layer 40 covering the circumference of the charge body 38. Thereby, the indicator 30 can be formed in a small diameter so as to be easily grasped with a hand, and be formed in a comfortable nib form.

It is desirable that the charge unit 36 of the indicator 30 is detachably combined with the body unit 32 of the indicator 30, as illustrated in FIG. 3. Thereby, when the amount of electric charges in the charge unit 36 decreases, the charge unit 36 can be replaced with a fully-charged charge unit 36. From the viewpoint of reducing the number of replacement of the charge unit 36, it is desirable that the charge body 38 included in the charge unit 36 is composed of the electret which is excellent in the electric charge retainment property. It is desirable that the circumference of the charge body 38 is covered with the insulating layer 40 to restrain the discharge of the electric charges.

### Second Embodiment

In the input device according to a second embodiment, a function of the position detector 58 differs from that of the position detector 58 according to the first embodiment. However, the whole composition, the operation panel, and the indicator are the same as those of FIGS. 1 to 3 according to the first embodiment. The position detector 58 included in the input device of the second embodiment calculates approximate lines of electric potentials in the first direction and the second direction from the measurement result of the electric potentials measured by the electric potential measurement unit 52, and specifies positions in the first direction and the second direction in which the absolute values of the electric potentials are maximum, based on the approximate lines. Then, the position detector 58 detects the position of the indicator 30 from the specified positions in the first direction and the second direction.

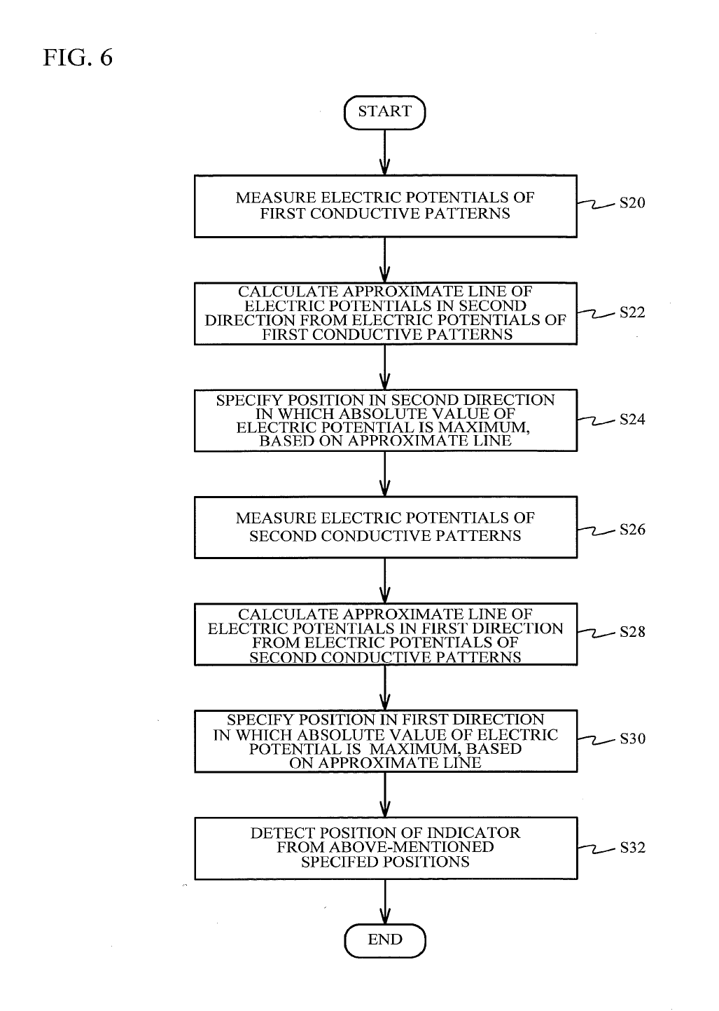

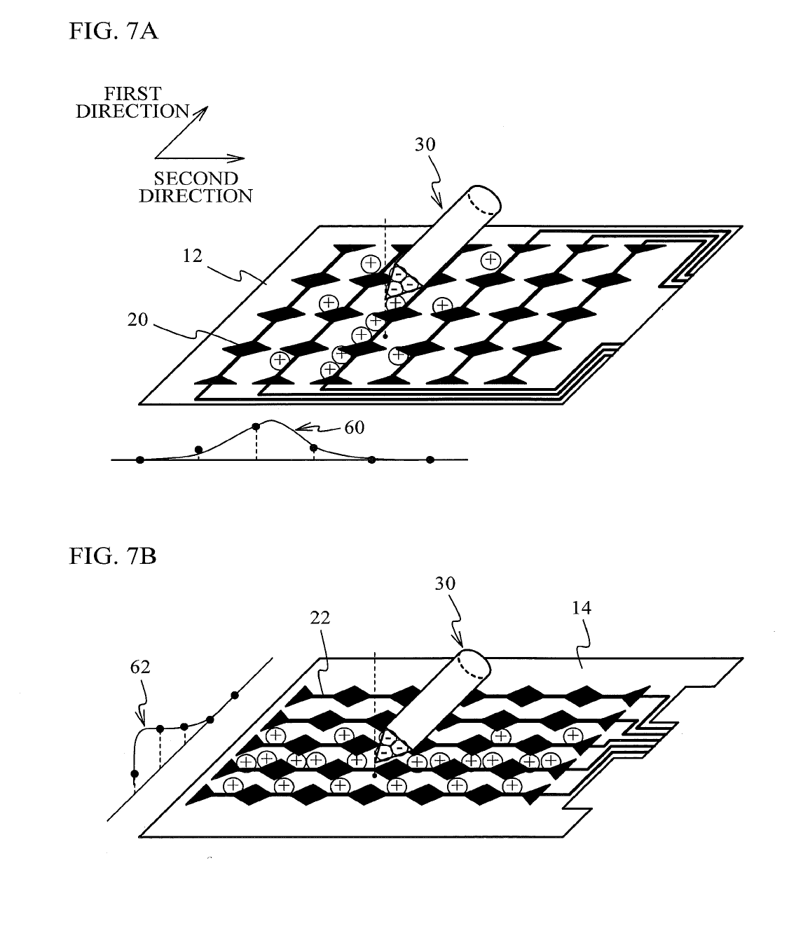

A description will be given of the control of the position detection unit 50 included in the input device of the second embodiment by use of FIGS. 6 and 7. FIG. 6 is a flowchart for explaining the control of the detection unit 50 included in the input device according to the second embodiment. FIG. 7A and 7B are diagrams for explaining approximate lines of electric potentials calculated by the position detection unit 50 included in the input device according to the second embodiment.

As illustrated in FIG. 6, the electric potential measurement unit 52 measures the electric potentials of the first conductive patterns 20 from the edge in turn (step S20). As explained in FIG. 4 of the first embodiment, in the state (i.e., the hovering state) where the indicator 30 comes close to the operation panel 10, the electric potential difference arises between the first conductive patterns 20. The position detector 58 calculates an approximate line of the electric potentials in the second direction from the measurement result of the electric potentials measured by the electric potential measurement unit 52 in step S20 (step S22). That is, the position detector 58 calculates an approximate line 60 of the electric potentials in the second direction, as illustrated in FIG. 7A. Then, the position detector 58 specifies a position in the second direction in which the absolute value of the electric potential is maximum, based on the approximate line 60 calculated in step S22 (step S24).

After the measurement of the electric potentials of the first conductive patterns 20, the electric potential measurement unit 52 measures the electric potentials of the second conductive patterns 22 from the edge in turn (step S26). As with the first conductive patterns 20, in the state (i.e., the hovering state) where the indicator 30 comes close to the operation panel 10, the electric potential difference arises between the second conductive patterns 22. The position detector 58 calculates an approximate line of the electric potentials in the first direction from the measurement result of the electric potentials measured by the electric potential measurement unit 52 in step S26 (step S28). That is, the position detector 58 calculates an approximate line 62 of the electric potentials in the first direction, as illustrated in FIG. 7B. Then, the position detector 58 specifies a position in the first direction in which the absolute value of the electric potential is maximum, based on the approximate line 62 calculated in step S28 (step S30).

Next, the position detector 58 detects the position of the indicator 30 from the position in the second direction specified in step S24 and the position in the first direction specified in step S30 (step S32).

As described above, according to the second embodiment, the position detector 58 calculates the approximate line 60 of the electric potentials in the second direction from the respective electric potentials of the first conductive patterns 20, and specifies the position in the second direction in which the absolute value of the electric potential is maximum, based on the approximate line 60. Similarly, the position detector 58 calculates the approximate line 62 of the electric potentials in the first direction from the respective electric potentials of the second conductive patterns 22, and specifies the position in the first direction in which the absolute value of the electric potential is maximum, based on the approximate line 62. Then, the position detector 58 detects the position of the indicator 30 from the specified position in the second direction and the specified position in the first direction. Thus, the position of the indicator 30 can be detected with high accuracy by using the approximate lines even when intervals between the first conductive patterns 20 and/or the second conductive patterns 22 are wide.

The position detection unit 50 may store beforehand, into a storage, not shown, a database of the total of the electric potentials which arise in the first conductive patterns 20 and the second conductive patterns 22 according to an interval between the operation panel 10 and the indicator 30. Then, the position detection unit 50 may include a function that detects the interval between the operation panel 10 and the indicator 30 by comparing the total of the electric potentials of the first conductive patterns 20 and the second conductive patterns 22 measured when the indicator 30 comes close to the operation panel 10, with the database in the storage.

In the first and the second embodiments, the charge unit 36 of the indicator 30 is charged with the negative electric charges, but the charge unit 36 may be charged with positive electric charges. As illustrated in FIG. 2, the first conductive patterns 20 and the second conductive patterns 22 are formed on different films, respectively, but the first conductive patterns 20 and the second conductive patterns 22 may be formed on the same film. In this case, the first conductive patterns 20 and the second conductive patterns 22 needs to be insulated at crossing portions mutually. The first conductive patterns 20 and the second conductive patterns 22 are not limited to diamond-shaped patterns, and may be other patterns, such as linear patterns with given widths.

The operation panel 10 is arranged on a front surface of a display, such as a LCD (Liquid Crystal Display), and is formed with a transparent material such as a touch panel. However, the input device 100 is not limited to this. For example, the operation panel 10 may be formed with an opaque material such as a touch pad. In this case, the first conductive patterns 20 and the second conductive patterns 22 may be formed on FPC (Flexible printed circuits), for example. Moreover, the first conductive patterns 20 and the second conductive patterns 22 may be arranged on the back side of the display, such as the LCD.

In the first and the second embodiments, the indicator 30 is used in the state (i.e., the hovering state) where the indicator 30 is away from the operation panel 10. However, the indicator 30 may be used while the indicator 30 contacts the operation panel 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An input device comprising:
an operation panel including:
a plurality of first conductive patterns that extend in a first direction, and are arranged in a second direction crossing the first direction; and
a plurality of second conductive patterns that extend in the second direction, and are arranged in the first direction;
an indicator that includes a charge unit charged with electric charges; and
a position detection unit that, when the indicator comes close to the operation panel, measures electric potentials by electric charges which arise in the first conductive patterns and the second conductive patterns by the charge unit of the indicator, and detects a position of the indicator based on a measurement result of the electric potentials.

2. The input device as claimed in claim 1, wherein the position detection unit calculates a first approximate line of the electric potentials in the second direction from the respective electric potentials of the first conductive patterns, specifies a position in the second direction in which an absolute value of an electric potential is maximum, based on the first approximate line, calculates a second approximate line of the electric potentials in the first direction from the respective electric potentials of the second conductive patterns, specifies a position in the first direction in which an absolute value of an electric potential is maximum, based on the second approximate line, and detects the position of the indicator based on the specified position in the first direction and the specified position in the second direction.

3. The input device as claimed in claim 1, wherein the position detection unit specifies one of the first conductive patterns in which an absolute value of an electric potential is maximum and one of the second conductive patterns in which an absolute value of an electric potential is maximum, and detects a position where the specified first conductive pattern and the specified second conductive pattern cross mutually, as position of the indicator.

4. The input device as claimed in claim 1, wherein the indicator includes a body unit, and the charge unit of the indicator is detachably combined with the body unit of the indicator.

5. The input device as claimed in claim 1, wherein the charge unit of the indicator includes a charge body storing the electric charges.

6. The input device as claimed in claim 5, wherein the charge body is composed of an electret.

7. The input device as claimed in claim 5, wherein the circumference of the charge body is covered with an insulating layer.

8. The input device as claimed in claim 1, wherein the position detection unit stores beforehand a database of the total of the electric potentials which arise in the first conductive patterns and the second conductive patterns according to an interval between the operation panel and the indicator, and detects the interval between the operation panel and the indicator by comparing the total of the electric potentials of measured first conductive patterns and measured second conductive patterns with the database.

9. An input device comprising:
an operation panel including:
a plurality of first conductive patterns that extend in a first direction, and are arranged in a second direction crossing the first direction; and
a plurality of second conductive patterns that extend in the second direction, and are arranged in the first direction; and
a position detection unit that, when the indicator comes close to the operation panel storing electric charges, measures electric potentials by electric charges which arise in the first conductive patterns and the second conductive patterns by the indicator, and detects a position of the indicator by specifying one of the first conductive patterns in which an absolute value of an electric potential is maximum and one of the second conductive patterns in which an absolute value of an electric potential is maximum.
